(19) United States
(12) Patent Application Publication
(10) Pub. No.: US 2009/0072952 A1
(43) Pub. Date: Mar. 19, 2009

(54) WIRELESS TAG PROCESSING APPARATUS, PROCESSING SYSTEM AND WIRLESS TAG PROCESSING METHOD

(75) Inventors: Kenichi NIIYAMA, Saitama-shi (JP); Satoshi Misawa, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/053,230

(22) Filed: Mar. 21, 2008

(30) Foreign Application Priority Data
Sep. 13, 2007 (JP) 2007-238549

(51) Int. Cl. H04Q 5/22

(52) U.S. Cl. 340/10.51

(57) ABSTRACT

The wireless tag processing apparatus is provided with: a transportation unit that transports a medium holding plural wireless tags; and a plurality of at least selected ones from writing units and reading units arranged so as to perform at least any one of an operation to write information with respect to each of the plural wireless tags in the medium transported by the transportation unit, and an operation to read information from each of the plural wireless tags.

### CROSS REFERENCE TO RELATED APPLICATIONS

This application is based on and claims priority under 35 USC §119 from Japanese Patent Application No. 2007-238549 filed Sep. 13, 2007.

### BACKGROUND

1. Technical Field

The present invention relates to a wireless tag processing apparatus and the like that perform an operation to write information into a wireless tag and the like, a processing system and a wireless tag processing method.

2. Related Art

In recent years, identification technologies using RFID (radio frequency identification) have been increasingly used with the developments of semiconductor technologies and electronic communication technologies and with price-reduction according to mass production. In addition, it is also expected that the high convenience of RFID will lead to considerably large expansion of the market size for products and services relating to RFID in the future.

Fields and modes in which wireless tags are used are different depending on users, as a matter of course. For this reason, no particular information is written to a wireless tag immediately after the manufacturing, and then information depending on a user is written to the wireless tag.

### SUMMARY

According to an aspect of the invention, there is provided a wireless tag processing apparatus including: a transportation unit that transports a medium holding plural wireless tags; and a plurality of at least selected ones from writing units and reading units arranged so as to perform at least any one of an operation to write information with respect to each of the plural wireless tags in the medium transported by the transportation unit, and an operation to read information from each of the plural wireless tags.

### BRIEF DESCRIPTION OF THE DRAWINGS

Exemplary embodiment(s) of the present invention will be described in detail based on the following figures, wherein:

FIG. 1 is a schematic configuration diagram that shows a processing system according to the first exemplary embodiment;

FIGS. 2A and 2B show the sheet having the images formed by the image forming apparatus;

FIG. 3 shows an example of the information stored in the data server;

FIGS. 4 and 5 are diagrams for explaining the reader/writer apparatus;

FIG. 6 is a perspective view that shows the first suppressing unit and the like together with the sheet;

FIG. 7 is a plane view that shows the first suppressing unit and the like together with the sheet;

FIG. 8 is a perspective view that shows the first suppressing unit and the second suppressing unit together with the belt member;

FIGS. 9A and 9B show the first suppressing unit and the like in an enlarged mode;

FIGS. 10A and 10B show a modified example of the first suppressing unit and the like;

FIG. 11 is a flowchart that shows the operations of the reader/writer apparatus and the like;

FIGS. 12A to 12D are diagrams for explaining errors in the transportation of the sheet;

FIG. 13 shows a system for a case where the image forming apparatus forms images after the reader/writer apparatus performs the reading and writing operations;

FIG. 14A shows a top view of the first suppressing unit in the second exemplary embodiment;

FIG. 14B shows a front view of the first suppressing unit in the second exemplary embodiment;

FIGS. 15A to 15C are diagrams for explaining operations of the reader/writer parts;

FIG. 16A shows a top view of the reader/writer parts in the third exemplary embodiment;

FIG. 16B shows a front view of the reader/writer parts in the third exemplary embodiment; and

FIGS. 17A to 17H are diagrams for explaining operations of the reader/writer parts when the sheet is transported.

### DETAILED DESCRIPTION

### First Exemplary Embodiment

Hereinafter, a first exemplary embodiment of the present invention will be described in detail by referring to the accompanying drawings.

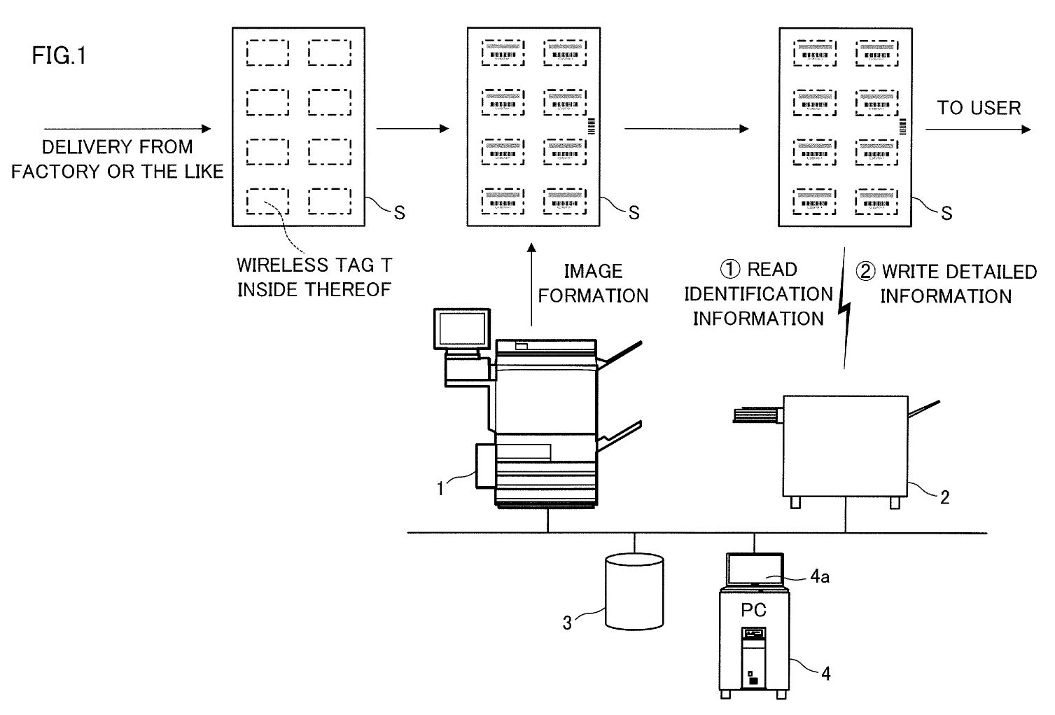

FIG. 1 is a schematic configuration diagram that shows a processing system according to the first exemplary embodiment.

As shown in FIG. 1, this processing system is provided with an image forming apparatus 1, a reader/writer apparatus 2 (one example of a wireless tag processing apparatus) and a data server 3. The image forming apparatus 1 forms images on a sheet S having multiple wireless tags T (simply called “tags T” below) embedded therein. The reader/writer apparatus 2 writes information to the tags T embedded in the sheet S or reads information from the tags T. The data server 3 stores information written to the tags T and information read from the tags T. In addition, this processing system is provided with a display panel (monitor) 4a that displays information, and a controller 4 that receives an image forming condition in the image forming apparatus 1, various conditions in the reader/writer apparatus 2, and the information written to the tags T. Incidentally, the controller 4 in the first exemplary embodiment is configured of a personal computer (PC).

In the first place, in this processing system, the image forming apparatus 1 forms images on the sheet S delivered from a factory or the like. Then, the reader/writer apparatus 2 reads, from each of the multiple tags T embedded in the sheet S, unique identification information (an identification number: also called a unique number (UID)) (Hereinafter, called “identification information” in this specification) stored in the tag T, and writes information to each of the tags T. Thereafter, the sheet S is delivered to a user or the like.

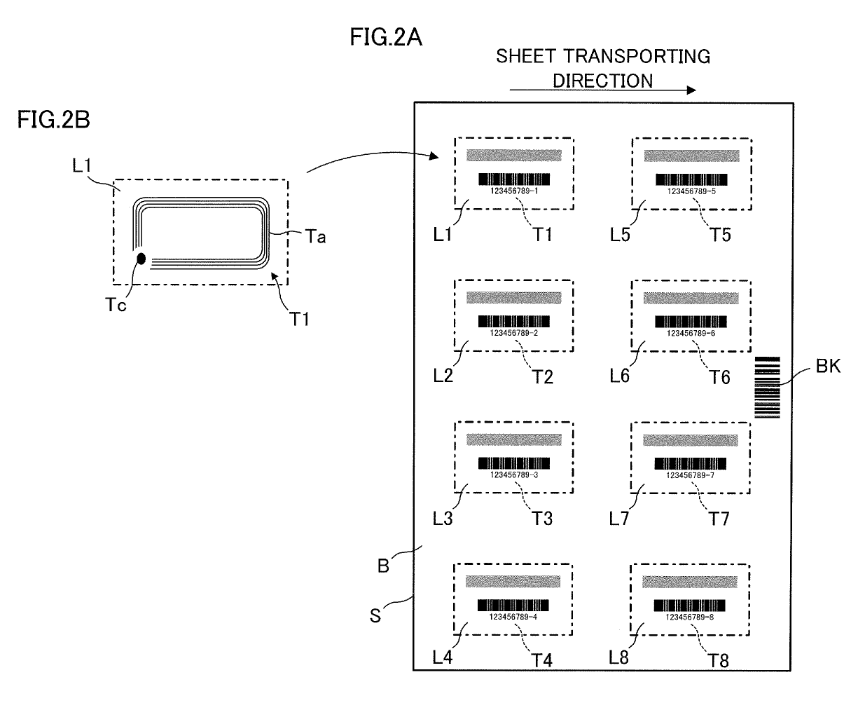

Here, FIGS. 2A and 2B show the sheet S having the images formed by the image forming apparatus 1.

As shown in FIG. 2A, the sheet S, which is one example of the medium, includes a base B formed in a rectangular shape and multiple labels L1 to L8 (hereinafter, also called “labels L”) provided in the base B to be removable.

An adhesive is applied to the back sides of these multiple labels L1 to L8. Each of the labels L is removed from the base B and then attached to, for example, a book, a digital versatile disk (DVD) and a compact disc (CD). The labels L in the first exemplary embodiment are arranged in a structure having 4 columns in a longitudinal direction of the sheet S and 2 lines in a short-side direction of the sheet S, in other words, in a matrix of 4×2. Incidentally, in the first exemplary embodiment, the sheet S is transported in its short-side direction inside the image forming apparatus 1 and the reader/writer apparatus 2. Accordingly, stating in relation to the transporting direction of the sheet S, four labels L5 to L8 are provided on the downstream side in the sheet transporting direction, and four labels L1 to L4 are provided on the upstream side in the sheet transporting direction.

Moreover, in the first exemplary embodiment, the tags T1 to T8 are embedded inside (held by) the respective labels L. Here, the label L1 is explained as one example. As shown in FIG. 2B, the tag T1 is embedded inside the label L1. The tag T1 in the first exemplary embodiment includes, as basic circuit elements, an antenna coil Ta, a capacitor for constituting a resonance circuit, and an IC chip Tc that stores information. Incidentally, the capacitor is sometimes incorporated in the antenna coil Ta, or is sometimes built in the IC chip Tc.

Note that any wireless tag that has been used heretofore may be employed as the tag T1, and there is no limitation on types of usable tags. In some cases, the tag T1 is also referred to as an RFID tag, an IC tag, a non-contact data carrier, a wireless IC tag, a non-contact IC, a non-contact IC label, a non-contact IC tag or the like. In addition, the tag T1 in the first exemplary embodiment does not include a battery and is configured of a so-called passive tag that generates power by use of radio waves from a reader/writer unit, which will be described later. However, the tag T1 is not limited to the passive type, but may be configured of a so-called active tag including a battery therein.

When the image forming apparatus 1 completes the image formation, the sheet S is in a state shown in FIG. 2A. The first exemplary embodiment is explained by using as an example a case where the label L is attached to a book (an example of an object having a tag attached thereto) to be lent out from a library. However, application of the tag T is not limited to this case of the library. For instance, the tag T may be attached to a rental DVD or a rental video tape in a rental shop. Instead, the tag T may be used for production management or inventory management in various kinds of factories or shops. When the image forming apparatus 1 completes the image formation, in the first exemplary embodiment, the name of a library in which a book is stored, a barcode and the numerals indicating the barcode information, for example, are printed on the surface of each of the labels L. In addition, a sheet identification barcode BK for discriminating this sheet S from the other sheets is printed on one side in the short-side direction of the sheet S.

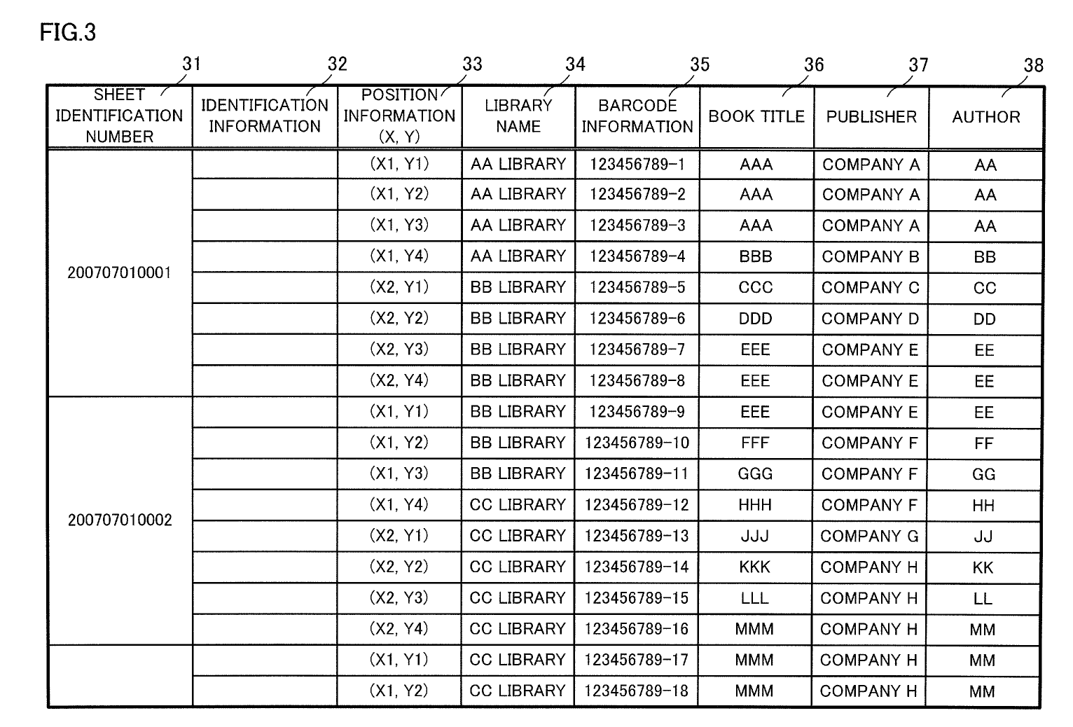

Here, the image forming apparatus 1 forms the images on the surface of the sheet S according to information stored in the data server 3. Here, FIG. 3 shows an example of the information stored in the data server 3.

In the data server 3, for example, library names 34 of the libraries in which books are stored, barcode information 35, book titles 36, publishers 37, authors 38 and the like are stored in association with each other as shown in FIG. 3. Moreover, this data server 3 also stores position information (X, Y) 33 indicating a position where each image is formed when the image forming apparatus 1 forms the image. Each piece of the position information 33 is also stored in the data server 3 in association with the library name 34, the barcode information 35, the book title 36, the publisher 37, the author 38 and the like. In addition, the identification information read from the tag T by the reader/writer apparatus 2 is stored in the data server 3 (see reference numeral 32). The identification information is also stored in association with the library names 34, the barcode information 35 and the like.

Here, a positional (arrangement) relationship specified by the position information 33 corresponds to (accords with) a positional (arrangement) relationship of each of the labels L (the tags T) arranged on the sheet S.

Specifically, the pieces of position information (X1, Y1), (X1, Y2), (X1, Y3) and (X1, Y4) correspond to the labels L1, L2, L3 and L4, respectively. In addition, the pieces of position information (X2, Y1), (X2, Y2), (X2, Y3) and (X2, Y4) correspond to the labels L5, L6, L7 and L8, respectively. For example, when the position information 33 is (X1, Y1), the image forming apparatus 1 forms an image on the label L1. Moreover, for instance, when the position information 33 is (X2, Y3), the image forming apparatus 1 forms an image on the label L7.

Note that, the data server 3 may automatically allocate these pieces of the position information 33 to the respective library names 34 when the information such as the library names 34 is stored in the data server 3, for example. Instead, this allocation may be performed by the controller 4.

In addition, the data server 3 stores sheet identification numbers (medium identification information) for discriminating the sheet S from other sheets (see Reference numeral 31). In the first exemplary embodiment, one sheet identification number is generated for 8 pieces of information corresponding to 8 labels L provided on one sheet S. This sheet identification number may be automatically allocated to every sheet by the data server 3 when the data server 3 stores the library names 34 and the like therein.

Here, operations of the image forming apparatus 1 are described.

The image forming apparatus 1 firstly acquires information on one sheet from the data server 3 when forming images on the sheet S. Next, the image forming apparatus 1 forms the images on the sheet S according to the obtained information. More precisely, the image forming apparatus 1 firstly generates a barcode based on the barcode information 35, and concurrently forms an image in which the barcode, numeric characters visually representing a piece of the barcode information 35, and a character string of a library name are arranged in a predetermined positional relationship. Thereafter, the image forming apparatus 1 disposes this image in the position corresponding to the position information 33. The image forming apparatus 1 performs this processing for 8 labels L and thereby forming the whole image. In addition, the image forming apparatus 1 generates the sheet identification barcode BK based on the sheet identification number 31, and generates an image by combining the sheet identification barcode BK with the above whole image. Then, the image forming apparatus 1 forms the image after the combining, on the sheet S positioned at a predetermined location.

As a result, for example, “AA library,” “barcode,” and the numeric characters “123456789-1” visually representing a piece of the barcode information are printed in the label L1 on the sheet S. In addition, the sheet identification barcode BK formed by bar-coding the sheet identification number “200707010001” is printed on the right edge portion of the sheet S (one edge portion in the sheet transporting direction) (see FIG. 2A).

Note that the image forming apparatus 1 in the first exemplary embodiment employs what is termed as an electrographic method, and forms an electrostatic latent image on a photosensitive drum by use of an exposure device (not illustrated in the figure) according to image data of each color. Here, the photosensitive drum corresponding to each color is provided to the image forming apparatus 1. After forming the electrostatic latent images, the image forming apparatus 1 forms the image on the sheet S in a way that the electrostatic latent images are developed with the respective color toners, are transferred onto the sheet S, and then are fixed. Incidentally, the image forming apparatus 1 may also employ what is termed as an ink-jet printing method or a printing method using thermal paper.

Subsequently, in the first exemplary embodiment, the reader/writer apparatus 2 reads the identification information from each tag T, and writes the information on the library name 34, the barcode information 35, the book title 36, the publisher 37 and the author 38 (information on an object to which a tag is attached, i.e., tag-attached object information) to each tag T.

Note that, in this description, the information written to each tag T is called below “detailed information.”

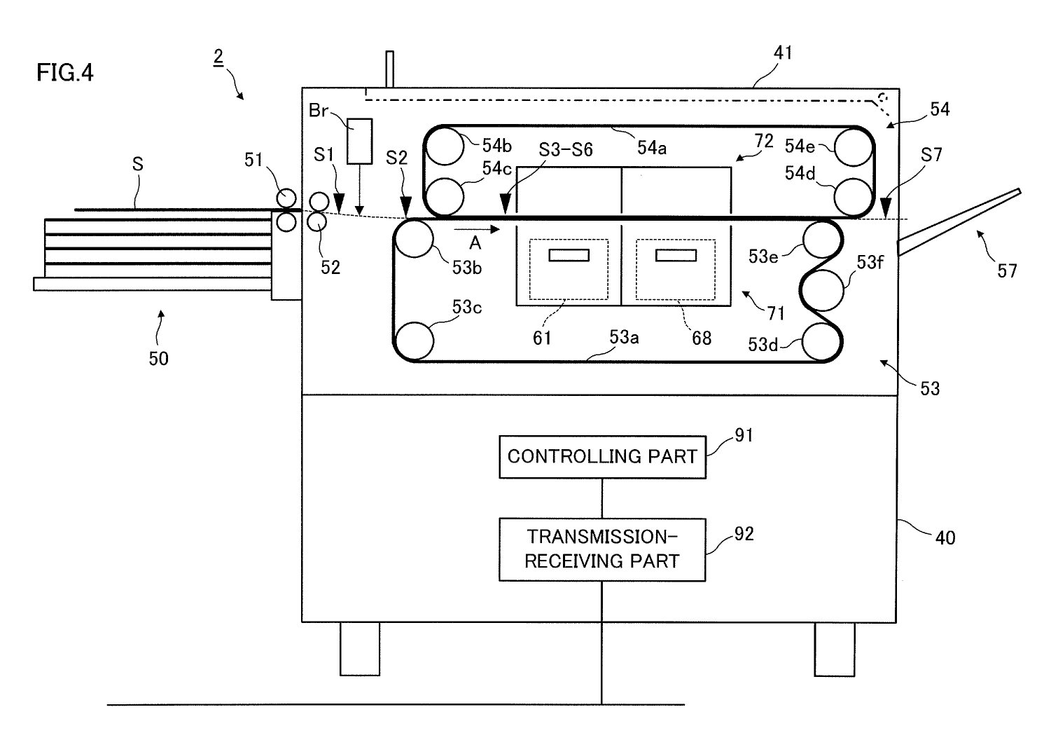

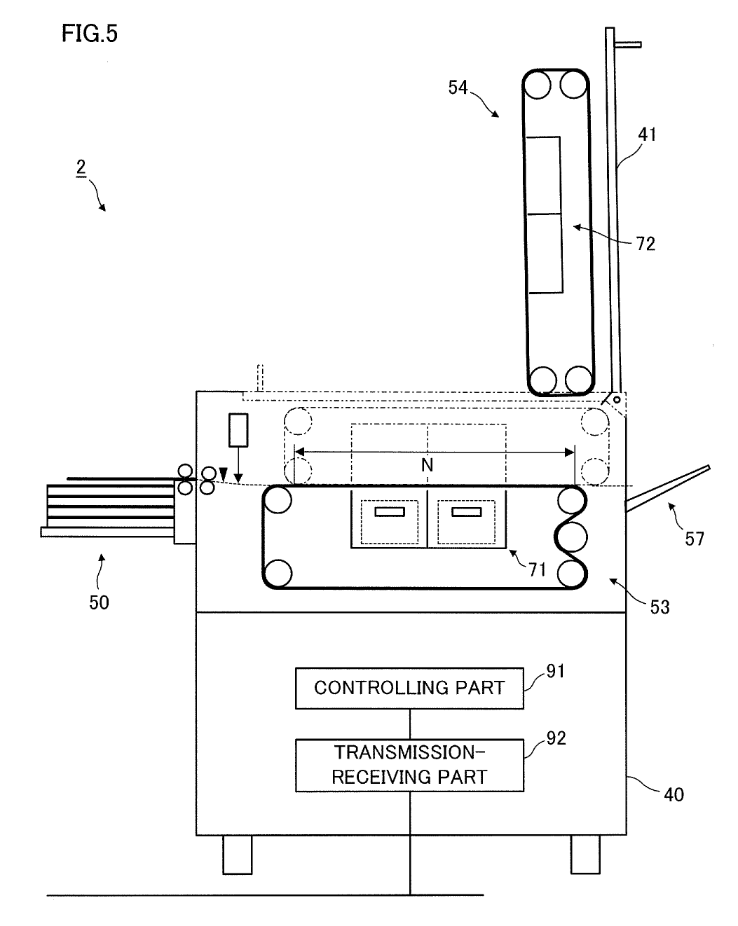

Here, FIGS. 4 and 5 are diagrams for explaining the reader/writer apparatus 2.

As shown in FIG. 4, the reader/writer apparatus 2 in the first exemplary embodiment includes an apparatus main body 40, and an opening-and-closing plate 41 provided on the upper side of the apparatus main body 40 and attached to the apparatus main body 40 in an openable and closable manner.

In addition, the reader/writer apparatus 2 includes, as a sheet transporting system, a sheet supplying unit 50, a pair of feeding rolls 51, a pair of transporting rolls 52, a first belt unit 53, a second belt unit 54 and a storage unit 57. The sheet supplying unit 50 has multiple sheets S stored thereon. The feeding rolls 51 feed the sheets S one by one, from the multiple sheets S stored on the sheet supplying unit 50 to the inside of the apparatus main body 40. The transporting rolls 52 further transport the sheet S fed by the feeding rolls 51, toward the downstream side in the transporting direction. Then, the first belt unit 53 and the second belt unit 54 transport the sheet S transported by the transporting rolls 52, toward the further downstream side in the transporting direction. The storage unit 57 stacks the sheets S transported by the first belt unit 53 and the second belt unit 54 in a thickness direction of the sheets S, and stores the sheets S. In the first exemplary embodiment, the feeding rolls 51, the transporting rolls 52, the first belt unit 53, the second belt unit 54 and the like function as a transportation unit.

Moreover, the reader/writer apparatus 2 in the first exemplary embodiment includes multiple reader/writer parts 61 to 68 (only the reader/writer parts 61 and 68 are shown in FIG. 4) that read or write the information from or to the tags T embedded in the sheet S. Additionally, the reader/writer apparatus 2 includes a first suppressing unit 71 and a second suppressing unit 72 as one example of a suppressing unit for suppressing the interference of radio waves transmitted from the reader/writer parts 61 to 68.

Further, the reader/writer apparatus 2 includes a first sensor S1, a second sensor S2, third to sixth sensors S3 to S6, and a seventh sensor S7 provided along the transportation path of the sheet S. These sensors S1 to S7 each perform a predetermined output when the sheet S passes by.

Here, the first sensor S1 is arranged on the downstream side of the transporting rolls 52 in the sheet transporting direction, and on the upstream side of the reading position of a barcode reader Br, which will be described in detail later, in the sheet transporting direction. The second sensor S2 is arranged on the downstream side of the reading position of the barcode reader Br in the sheet transporting direction and on the upstream side of the second belt unit 54 in the sheet transporting direction. The third to sixth sensors S3 to S6 are arranged near the first suppressing unit 71 and the like and on the upstream side of the first suppressing unit 71 and the like in the sheet transporting direction. The seventh sensor S7 is arranged on the downstream side of a nip portion N which will be described later, in the sheet transporting direction. Incidentally, another sensor may be provided near the first suppressing unit 71 and the like and on the downstream side of the first suppressing unit 71 and the like in the sheet transporting direction.

Moreover, the reader/writer apparatus 2 is provided with the barcode reader Br that reads the sheet identification barcode BK formed on the sheet S, at the downstream side of the detection area of the first sensor S1 in the sheet transporting direction. Furthermore, the reader/writer apparatus 2 includes a controlling part 91 that controls each part (each apparatus), and a transmission-receiving part 92 that exchanges information with the data server 3, the controller 4 and the like.

More specifically, the first belt unit 53 includes a belt member 53a formed in an endless shape; first to fourth suspension rolls 53b, 53c, 53d and 53e that tightly suspend the belt member 53a from the inside thereof; and a tension roll 53f that applies a certain tension to the belt member 53a by pressing the belt member 53a from the outside. In the first exemplary embodiment, the first to fourth suspension rolls 53b, 53c, 53d and 53e are provided in such an arrangement where these four suspension rolls are separated from each other and positioned in the respective vertices of a rectangular shape.

To be more precise, the first suspension roll 53b is arranged on the side near the sheet transporting path and on the upstream side in the sheet transporting direction in the first belt unit 53, while the second suspension roll 53c is arranged on the side far from the sheet transporting path and on the upstream side in the sheet transporting direction in the first belt unit 53. On the other hand, the third suspension roll 53d is arranged on the side far from the sheet transporting path and on the downstream side in the sheet transporting direction in the first belt unit 53, while the fourth suspension roll 53e is arranged on the side near the sheet transporting path and on the downstream side in the sheet transporting direction in the first belt unit 53.

In the first exemplary embodiment, a space for housing the first suppressing unit 71 is formed inside the belt member 53a as a result of the aforementioned arrangement of each of the suspension rolls 53b, 53c, 53d and 53e. Incidentally, the fourth suspension roll 53e in the first exemplary embodiment also functions as a driving roll for driving the belt member 53a to rotate in a direction shown by the arrow A in FIG. 4 by receiving driving force from a motor (not illustrated in the figure).

The second belt unit 54 is arranged above (in the position facing) the first belt unit 53. Moreover, the second belt unit 54 is arranged to be pressed against the first belt unit 53, and thereby the nip portion N is formed (see FIG. 5) where the sheet S is nipped from the upper and lower sides and thus transported with the first belt unit 53 and the second belt unit 54.

The second belt unit 54 includes a belt member 54a formed in an endless shape; and first to fourth suspension rolls 54b, 54c, 54d and 54e that tightly suspend the belt member 54a from the inside thereof. The belt member 54a and the belt member 53a in the first exemplary embodiment each are configured of a material (for example, a rubber material) that does not shield radio waves transmitted by antennas 61a to 68a to be described later.

In the second belt unit 54, the first to fourth suspension rolls 54b, 54c, 54d and 54e are also provided in such an arrangement that these four suspension rolls are separated from each other and positioned in the respective vertices of a rectangular shape (rectangle). Accordingly, in the second belt unit 54, a space for housing the second suppressing unit 72 is also formed inside the belt member 54a. In addition, the nip portion N is formed in a place where a flat portion of the belt member 53a is in contact with a flat portion of the belt member 54a. Thus, the transporting path is formed to be flat in the nip portion N.

Moreover, as shown in FIG. 5, the second belt unit 54 and the second suppressing unit 72 are movably provided to get away from or get close to the first belt unit 53 and the first suppressing unit 71, with (by following) the opening and closing of the opening-and-closing plate 41. This allows the sheet transporting path to be opened, so that the sheet S is easily removed in a case where the sheet S gets jammed in the sheet transporting path or in a similar case.

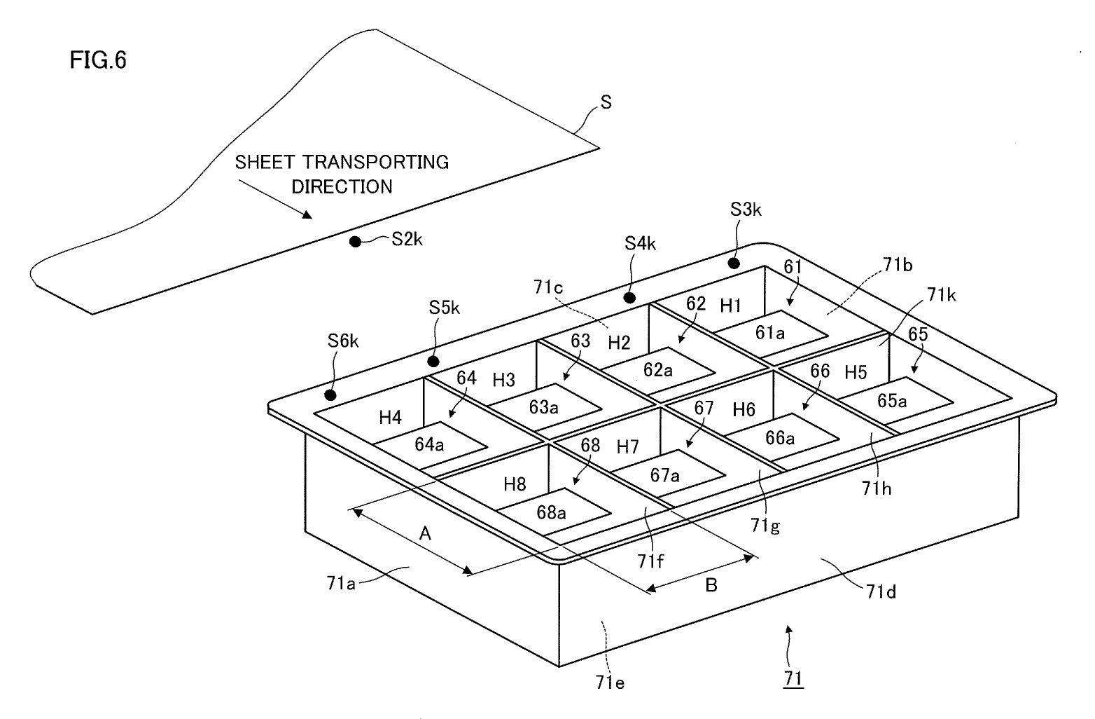

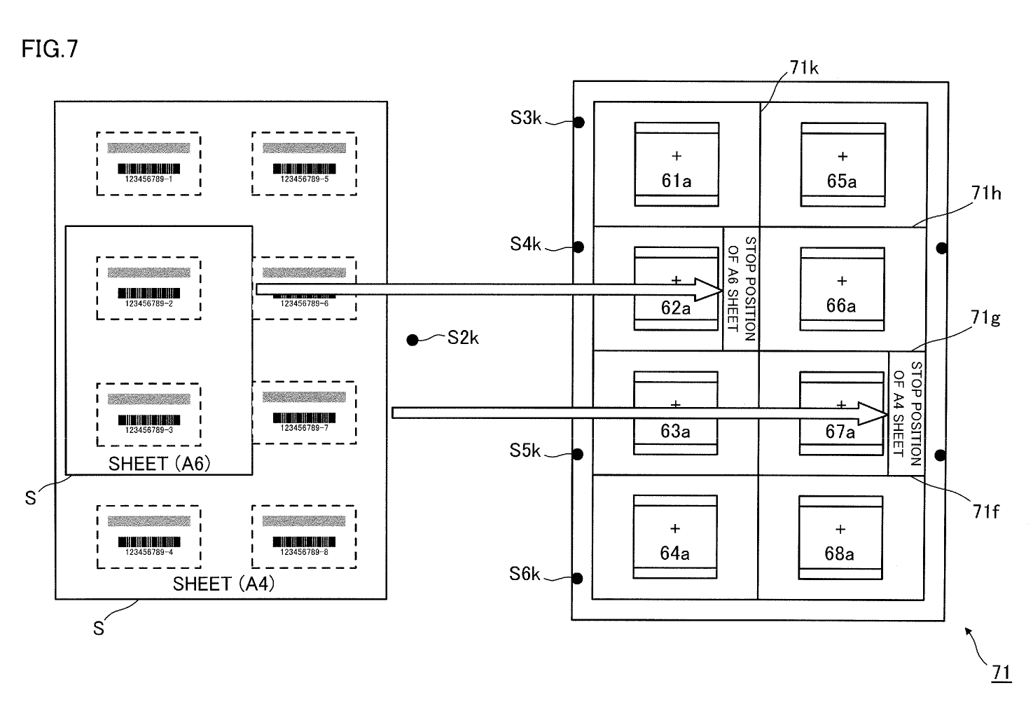

Hereinafter, the first suppressing unit 71 and the like will be described by using FIGS. 6 and 7. FIG. 6 is a perspective view that shows the first suppressing unit 71 and the like together with the sheet S, and FIG. 7 is a plane view that shows the first suppressing unit 71 and the like together with the sheet S.

As shown in FIG. 6, the first suppressing unit 71 in the first exemplary embodiment is formed to have an opening portion on the side on which the sheet S is transported (the sheet transporting side), and to have a box (rectangular parallelepiped) shape. In addition, the first suppressing unit 71 is arranged on one side of the transporting path of the sheet S. Moreover, the first suppressing unit 71 includes a first side wall 71a formed along the sheet S transporting direction; a second side wall 71b arranged in a position facing this first side wall 71a; a third side wall 71c formed along a direction perpendicular to the sheet S transporting direction; a fourth side wall 71d also formed along a direction perpendicular to the sheet S transporting direction; and a bottom portion 71e.

Moreover, the first suppressing unit 71 includes: a first partition member 71k that partitions the internal space into two sections in the sheet transporting direction; and a second partition member 71f, a third partition member 71g and a fourth partition member 71h that partition the internal space into four sections in a direction perpendicular to the sheet transporting direction.

Thus, the first suppressing unit 71 in the first exemplary embodiment is provided with closed spaces H1 to H8 arranged in a matrix. The closed spaces H1 to H8 are closed except for the opening provided on the sheet transporting side. The arrangement of the closed spaces H1 to H8 in the first exemplary embodiment is designed so that the closed spaces H1 to H8 face the respective tags T provided in the transported sheet S when the transported sheet S is arranged (stopped) in the position facing the first suppressing unit 71. In addition, the first suppressing unit 71 includes the reader/writer parts 61 to 68 which write and read the information to and from the respective tags T, in the respective closed spaces H1 to H8. Incidentally, the first partition member 71k, the second partition member 71f, the third partition member 71g and the fourth partition member 71h in the first exemplary embodiment function as one example of a shielding member on a transmitter side (transmitter-side shielding member).

Here, any conventionally-used reader/writer is usable as each of the reader/writer parts 61 to 68 and such usable readers/writers are not particularly limited to a certain type. As similar to the conventionally-used reader/writer, the reader/writer parts 61 to 68 in the first exemplary embodiment respectively includes: the antennas 61a to 68a that function as writing/reading units; demodulation circuits (not illustrated in the figure) that demodulate signals received by the antennas 61a to 68a; modulation circuits that modulate information to be transmitted and output the modulated information to the antennas 61a to 68a; and controlling parts that control the respective demodulation circuits and modulation circuits. Note that the antennas 61a to 68a in the first exemplary embodiment are provided in the positions corresponding to (according to) the arrangement relationship among the tags T embedded in the sheet S and thus are arranged in a matrix. Moreover, the antennas 61a to 68a in the first exemplary embodiment are each arranged to have a relationship corresponding to (according to) a positional (arrangement) relationship among the positions specified by the position information 33.

Further, the antennas 61a to 68a in the first exemplary embodiment are arranged so as to write information to the respective tags T1 to T8 in parallel (at the same time) and/or to read the information from the respective tags T1 to T8 in parallel (at the same time). Incidentally, the phrase “in parallel (at the same time)” is used only to describe an arrangement state of the antennas 61a to 68a. Hence, the actual reading and writing operations may be performed in a mode other than the parallel mode, in other words, for example, the antennas 61a to 68a are operated to asynchronously read and write the information from and to the respective tags T. For example, the antennas 61a to 68a may sequentially operate to write the information to the respective tags T1 to T8. Alternatively, the antennas 61a to 68a may randomly operate to write the information to the respective tags T1 to T8. Thus, even though the antennas 61a to 68a in the first exemplary embodiment are arranged so as to perform in parallel the writing operation of the information or the like, the antennas 61a to 68a may be operated at different timings when actually performing the writing operation of the information or the like.

Additionally, the first exemplary embodiment is set as follows. Specifically, a piece of information read by the reader/writer part 61 is to be stored in the data server 3 in association with the detailed information related to the position information (X1, Y1). Similarly, a piece of information read by the reader/writer part 62 is to be stored in the data server 3 in association with the detailed information related to the position information (X1, Y2). Moreover, pieces of information read by the reader/writer parts 63 and 64 are to be stored in the data server 3 in association with the detailed information related to the pieces of position information (X1, Y3) and (X1, Y4), respectively.

In addition, pieces of information read by the reader/writer parts 65 and 66 are to be stored in the data server 3 in association with the detailed information related to the position information (X2, Y1) and (X2, Y2), respectively. Furthermore, pieces of information read by the reader/writer parts 67 and 68 are to be stored in the data server 3 in association with the detailed information related to the position information (X2, Y3) and (X2, Y4), respectively.

For this reason, when the reader/writer part 61, for example, reads the identification information from the tag T, the read identification information is stored in the data server 3 in association with the detailed information related to the position information (X1, Y1). Similarly, when the reader/writer part 67, for example, reads the identification information from the tag T, the read identification information is stored in the data server 3 in association with the detailed information related to the position information (X2, Y3).

Moreover, the first exemplary embodiment is also set as follows. Specifically, the pieces of detailed information related to the position information (X1, Y1) and (X1, Y2) are to be outputted to the reader/writer parts 61 and 62, respectively. The pieces of detailed information related to the position information (X1, Y3) and (X1, Y4) are to be outputted to the reader/writer parts 63 and 64, respectively. In addition, the pieces of detailed information related to the position information (X2, Y1) and (X2, Y2) are to be outputted to the reader/writer parts 65 and 66, respectively. The pieces of detailed information related to the position information (X2, Y3) and (X2, Y4) are to be outputted to the reader/writer parts 67 and 68, respectively.

Accordingly, the detailed information such as the library name 34, the barcode information 35 and the book title 36 related to, for example, the position information (X1, Y1) is outputted to the reader/writer part 61, while the detailed information such as the library name 34, the barcode information 35 and the book title 36 related to, for example, the position information (X2, Y3) is outputted to the reader/writer part 67.

Here, usable materials for the first and second suppressing units 71 and 72 include stainless steel, brass, aluminum, copper, gold or the like. The first and second suppressing units 71 and 72 may be formed of any of these materials. Instead, the first and second suppressing units 71 and 72 may each have a configuration in which, while a main body thereof is formed of a resin material, a plate or a film formed of any of these materials is attached to the surface or the like of the main body, or a similar configuration. With this configuration, the first and second suppressing units 71 and 72 may be made more lightweight.

Each of the closed spaces H1 to H8 in the first exemplary embodiment has a rectangular shape in a plan view. In other words, each of the closed spaces H1 to H8 has a rectangular shape at the opening portion. Specifically, each of the closed spaces H1 to H8 is formed to extend in the sheet transporting direction at the opening portion.

To be more precise, each of the closed spaces H1 to H8 is formed to have the shape in which a length A in the sheet transporting direction is longer than a length B in a direction perpendicular to the sheet transporting direction. Although the detailed description will be provided later, the sheet S is stopped in the position facing the first suppressing unit 71. At this time, the sheet S is sometimes stopped out of the predetermined position, shifted in the sheet transporting direction. With the shape employed in the first exemplary embodiment, each of the reader/writer parts 61 to 68 appropriately writes and reads the information even when the sheet S is stopped out of the predetermined position.

Note that, although the first exemplary embodiment has been described by using the opening portion formed in the rectangular shape, the opening portion may be formed in a perfect circle shape or an oval shape. In the case of employing the oval shape, it is desirable to arrange the major axis along the sheet S transporting direction. In addition, although each of the closed spaces H1 to H8 in the first exemplary embodiment has the rectangular parallelepiped shape, each of the closed spaces H1 to H8 may have a cup shape, a dome shape, a quadrangular pyramid, a triangular pyramid or the like. When any of these shapes is employed, the closed space is formed to have an external diameter that becomes smaller and smaller from the opening portion side to the bottom side. Hence, the downsizing of the apparatus is achievable.

FIGS. 6 and 7 each additionally show a detection area S2k of the second sensor S2 which is described above and detection areas S3k to S6k of the third to sixth sensors S3 to S6. The third to sixth sensors S3 to S6 are arranged at predetermined intervals in a direction perpendicular to the sheet transporting direction, and their detection results are used to determine whether or not the sheet S is skewed or the like (the detail thereof will be described later).

The second sensor S2 (see FIG. 4) is arranged on the upstream side of the first suppressing unit 71. According to the detection result of the second sensor S2, the sheet S is arranged in the position facing the first suppressing unit 71.

More precisely, as shown in FIG. 7, for example, when the sheet S of A4 size is detected by the second sensor S2 (see FIG. 4, detection area of the second sensor S2 is indicated by S2k), the driving of the first belt unit 53 (a driving motor not illustrated in the figure) is stopped after a predetermined time period, so that the sheet S of A4 size is arranged in the position facing the first suppressing unit 71. More specifically, the sheet S is arranged to allow the tags T in the sheet S to face the respective closed spaces H1 to H8. In addition, when the sheet S of A6 size is detected by the second sensor S2, the driving of the first belt unit 53 is similarly stopped after a predetermined time period, so that the sheet S of A6 size is arranged in a certain position facing the first suppressing unit 71.

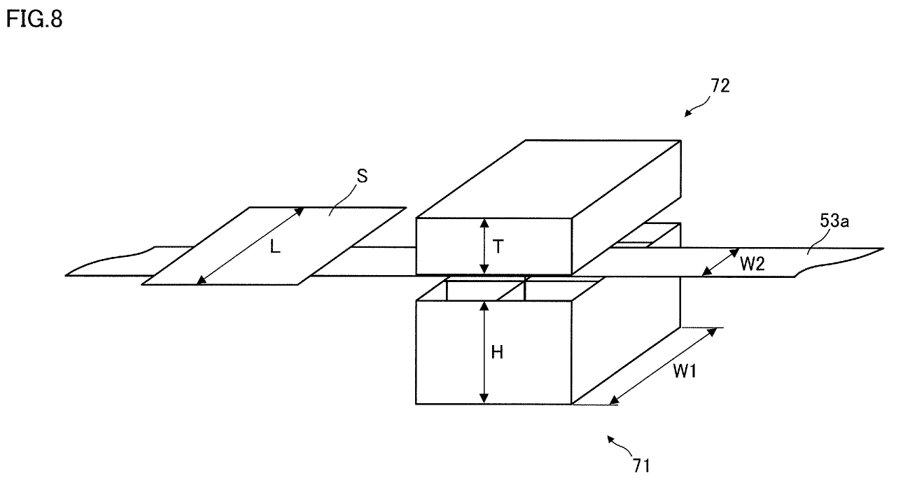

Here, FIG. 8 is a perspective view that shows the first suppressing unit 71 and the second suppressing unit 72 together with the belt member 53a. In FIG. 8, the illustration of the belt member 54a is omitted.

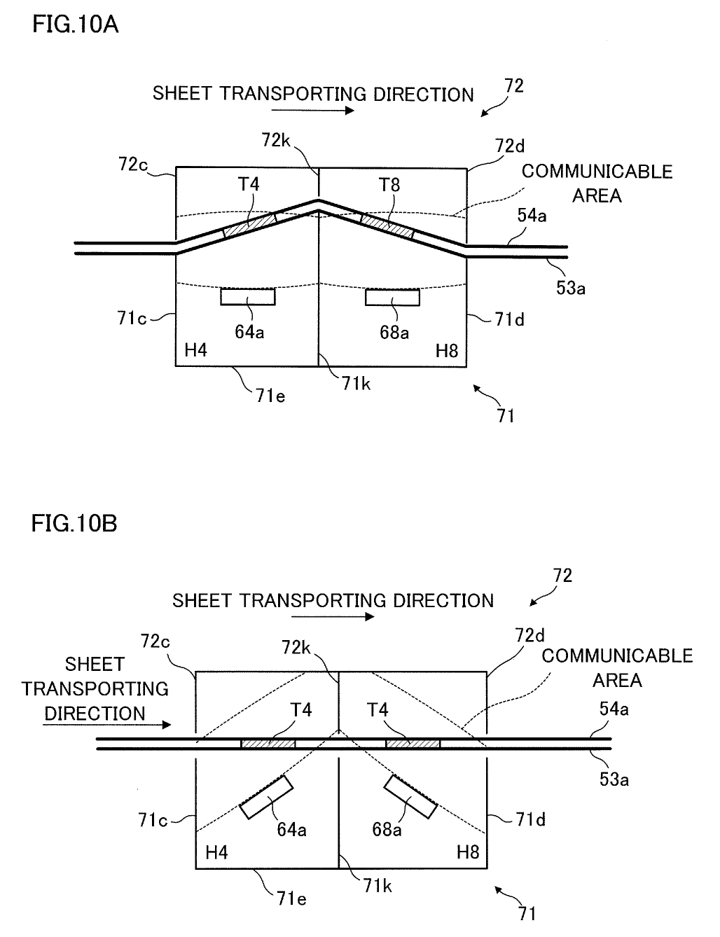

The second suppressing unit 72 has the same configuration as that of the first suppressing unit 71 except for the following two points. Firstly, the second suppressing unit 72 is not internally provided with the reader/writer parts 61 to 68. Secondly, a height dimension T (the length in a direction perpendicular to the sheet transporting direction) of the second suppressing unit 72 is smaller than a height dimension H of the first suppressing unit 71. In addition, in the second suppressing unit 72 thus configured, an opening portion is arranged in the position opposite to the opening portion of the first suppressing unit 71, and closed spaces H1 to H8 are arranged in the positions opposite to the respective closed spaces H1 to H8 of the first suppressing unit 71. As a result, the first partition member 71k, the second partition member 71f, the third partition member 71g and the fourth partition member 71h (see FIG. 6) in the first suppressing unit 71 are opposed to a first partition member 72k (see FIG. 10A), a second partition member, a third partition member and a fourth partition member (they are not illustrated in the figure) in the second suppressing unit 72, respectively. Incidentally, in the first exemplary embodiment, the first partition member 72k, the second partition member, the third partition member and the fourth partition member in the second suppressing unit 72 function as one example of a shielding member of an opposite side (opposite-side shielding member).

Additionally, in the first exemplary embodiment, the belt member 53a (and the belt member 54a as well) is formed to have a width dimension W2 shorter than a length L of the sheet S in a longitudinal direction, and thereby formed to partially overlap the sheet S. The narrowing of the width of the belt member 53a in this way leads to an achievement of the acquisition of the apparatus lighter in weight and smaller in size as a whole. In addition, the width dimension W2 of the belt member 53a is set at a value allowing the belt member 53a to pass between the detection areas S4k and S5k (see FIG. 7). This configuration prevents the belt member 53a from blocking the detections of the sheet S by the third to sixth sensors S3 to S6.

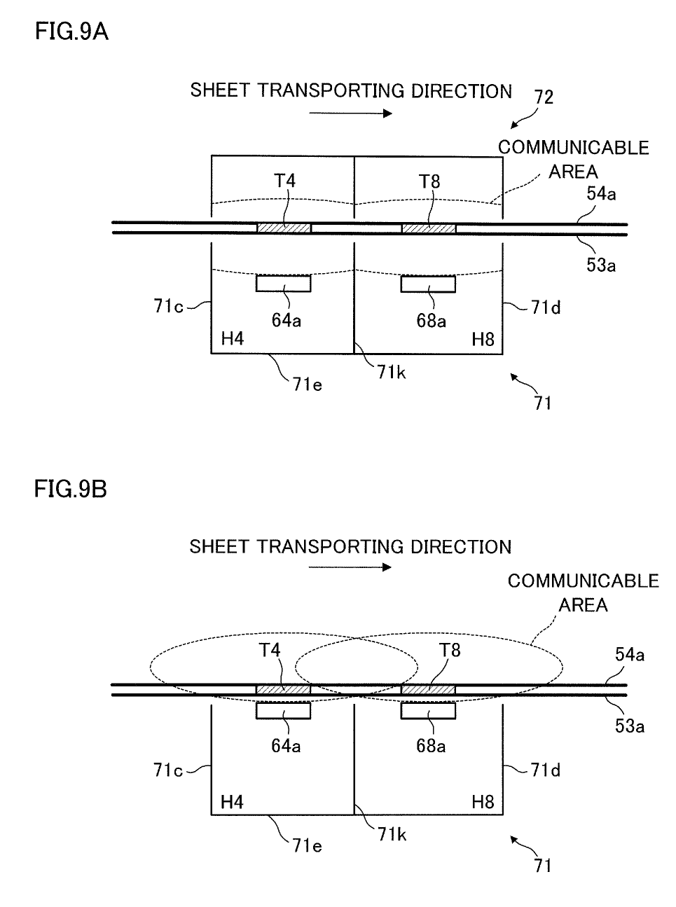

Here, FIGS. 9A and 9B show the first suppressing unit 71 and the like in an enlarged mode. As shown in FIG. 9A, each of the antennas 61a to 68a (FIG. 9A illustrates the antennas 64a and 68a) in the first exemplary embodiment is arranged to be closer to the bottom portion 71e than the edge portion (the upper edge) on the opening portion side of the first suppressing unit 71. In other words, each of the antennas 61a to 68a is arranged inside the corresponding one of the closed spaces H1 to H8 (FIG. 9A illustrates the closed spaces H4 and H8). More specifically, each of the antennas 61a to 68a is provided at a distance from the sheet transporting path larger than a distance between the sheet transporting path and the opening portion. That is to say, the first partition member 71k shielding radio waves transmitted by the antenna 64a and the like is provided between the antenna 64a and the antenna 68a.

In contrast, as shown in FIG. 9B, each of the antennas 61a to 68a may be arranged in alignment with the upper edge of the first suppressing unit 71. In this case, however, the radio waves transmitted by, for example, the antennas 64a and 68a may interfere with each other, and thereby the antennas 64a and 68a may fail to appropriately read the information from the tags T4 and T8, respectively. In addition, the antenna 64a may read the information from the tag T8 facing the antenna 68a, or the antenna 68a may read the information from the tag T4 facing the antenna 64a.

For this reason, in the first exemplary embodiment, each of the antennas 61a to 68a is arranged to be closer to the bottom portion 71e than the edge portion on the opening portion side of the first suppressing unit 71.

Moreover, the interference of the radio waves occurs not only at the side toward the first suppressing unit 71 from the belt members 53a and 54a, but also at the side opposite to the first suppressing unit 71. For this reason, the first exemplary embodiment has the configuration in which the second suppressing unit 72 is provided opposite to the first suppressing unit 71. Thus, the interference of the radio waves or the like is also suppressed in the opposite position to the first suppressing unit 71, so that the information is appropriately read from and written to the tags T.

Note that, in the case where the antennas 61a to 68a are arranged to be closer to the bottom portion 71e than the edge portion on the opening portion side of the first suppressing unit 71, the radio-wave transmittable area (communicable area) on the second suppressing unit 72 side is smaller than in the case shown in FIG. 9B. For this reason, in the first exemplary embodiment, the first and second suppressing units 71 and 72 are formed to have the different height dimensions, that is, as described above, the height dimension T of the second suppressing unit 72 is made smaller than the height dimension H of the first suppressing unit 71. This configuration leads to effective suppression of the interference of radio waves and also a weight reduction of the reader/writer apparatus 2. Moreover, in the first exemplary embodiment, the configuration in which such a small second suppressing unit 72 moves together with the opening-and-closing plate 41 allows the opening-and-closing plate 41 to be opened and closed lightly.

Here, FIGS. 10A and 10B show a modified example of the first suppressing unit 71 and the like. The first suppressing unit 71 and the second suppressing unit 72 may be configured as shown in FIG. 10A, for example.

Specifically, the first partition member 71k is formed to have a height dimension greater than those of the third side wall 71c and the fourth side wall 71d in the first suppressing unit 71, and the belt members 53a and 54a (the sheet S) are curved so as to follow the shape of the first suppressing unit 71. More precisely, the sheet S is curved so as to position both ends of the sheet S at the side away from the edge of the first partition member 71k on the sheet transporting path side in a direction perpendicular to the sheet transporting direction.

In the case of this configuration, the first partition member 71k is located between the tag T4 and the tag T8, so that the effect of shielding the radio waves is further enhanced.

Stating from another point of view, this modified example has the configuration in which the first partition member 71k located in the center of the first suppressing unit 71 is formed to have a height greater than those of the third side wall 71c and the fourth side wall 71d, and in which the belt members 53a and 54a are curved so as to approach the third side wall 71c and the fourth side wall 71d. In other words, the partition wall (first partition member 71k) in the center is formed to have a height greater than those of the side walls (third side wall 71c and fourth side wall 71d), and the belt members 53a and 54a are curved so as to approach the side walls.

In the first exemplary embodiment, the first partition member 71k, the third side wall 71c, the fourth side wall 71d and the like arranged along the sheet transporting direction are formed to have different heights. Instead, it should be noted that the first side wall 71a, the second partition member 71f, the third partition member 71g, the fourth partition member 71h and the second side wall 71b (see FIG. 6) arranged along the direction perpendicular to the sheet transporting direction may be formed to have different heights. In this case, for example, the third partition member 71g is the highest, and the second partition member 71f and the fourth partition member 71h each are the second highest. Meanwhile, the first side wall 71a and the second side wall 71b each are the lowest.

On the other hand, when the configuration shown in FIG. 10A is employed, it is preferable that the first partition member 72k be formed to have a height dimension smaller than those of the third side wall 72c and the fourth side wall 72d in the second suppressing unit 72. This is because the center portion of the first suppressing unit 71 inevitably largely protrudes upward, if the height dimension of the first partition member 72k is equal to those of the third side wall 72c and the fourth side wall 72d. The downsizing of the reader/writer apparatus 2 is achievable by designing the first partition member 72k to have a height dimension smaller than those of the third side wall 72c and the fourth side wall 72d.

In addition, in the foregoing configuration, the first suppressing unit 71 and the like and the belt member 53a and the like may come into contact with each other, so that these components are likely to be worn out or become in another unfavorable condition. For this reason, it is more preferable that a rotatable roller member or a member with a low coefficient of friction formed of a fluorine resin be provided to each of such contact portions.

Alternatively, as shown in FIG. 10B, the antenna 64a and the antenna 68a may be each arranged at a tilt while the surface including the antenna 64a formed in a flat shape and the surface including the antenna 68a also formed in a flat shape are tilted at different angles relative to the sheet transporting direction. Additionally, the antenna 64a and the antenna 68a may be each arranged at a tilt so that the surface including the radio-wave transmitting surface of the antenna 64a arranged on the upstream side of the sheet transporting direction, and the surface including the radio-wave transmitting surface of the antenna 68a arranged on the downstream side of the sheet transporting direction may cross each other. To be more precise, the radio-wave transmitting surface of the antenna 64a may be arranged to face the upstream side in the sheet transporting direction while the radio-wave transmitting surface of the antenna 68a may be arranged to face the downstream side in the sheet transporting direction.

A general antenna has directivity, and accordingly the antenna has higher radio-wave receiving sensitivity when the antenna and the tag T face each other. In a mode in FIG. 10B, since the antenna and the tag T do not face each other, the radio-wave receiving sensitivity of the antenna decreases. However, this mode is effective in terms of prevention of interference of radio waves. Note that, a configuration obtained by appropriately combining the mode in FIG. 10A with the mode in FIG. 10B is, of course, employable.

In addition, in FIGS. 10A and 10B, the modes have been described by using as examples the antenna 64a and the antenna 68a arranged along the sheet transporting direction, but the antennas 61a to 64a (see FIG. 6) arranged along the direction perpendicular to the sheet transporting direction, for example, may be also arranged at a tilt. In this case, the antennas 62a and 63a are tilted at a certain angle while the antennas 61a and 64a are tilted at an angle larger than the certain angle, for example. In other words, the antennas around the center are arranged to be tilted at a smaller angle, while the antennas around the edges are arranged to be tilted at a greater angle.

Hereinafter, operations of the reader/writer apparatus 2 and the like are described.

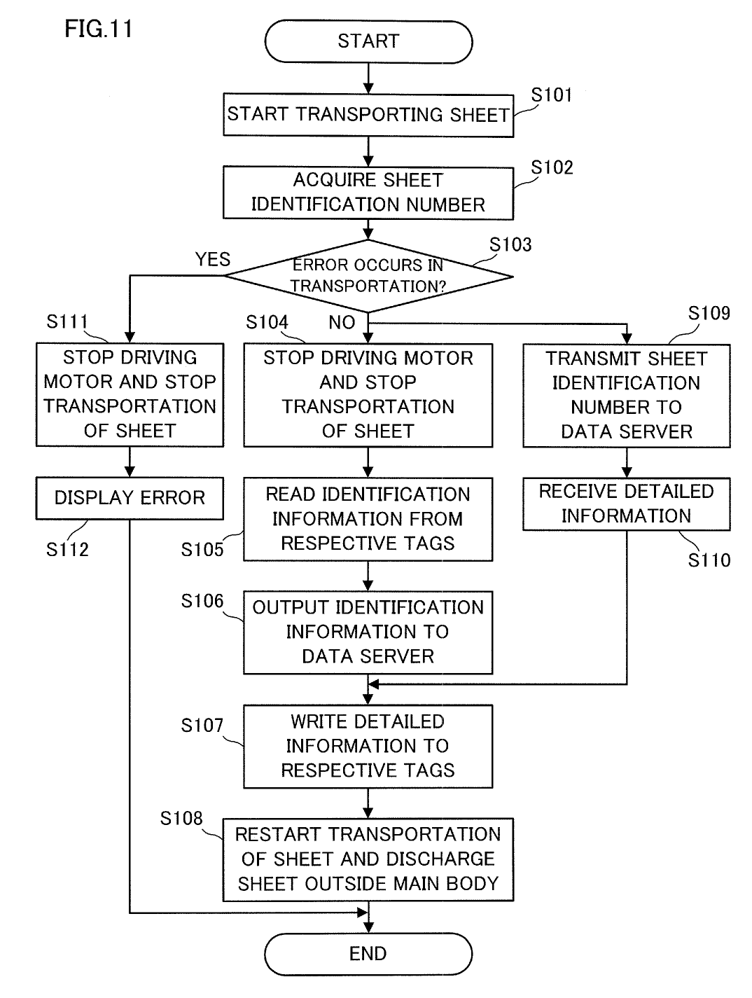

FIG. 11 is a flowchart that shows the operations of the reader/writer apparatus 2 and the like.

First, upon detection of press of a start button (not illustrated in the figure), the controlling part 91 rotates the feeding rolls 51, the transporting rolls 52 and the fourth suspension roll 53e by rotating the driving motors (not illustrated in the figure), and thereby causing these rolls to start transporting the sheet S stored on the sheet supplying unit 50 (step 101). Here, the controlling part 91 may otherwise start rotating the driving motors in accordance with an instruction from the controller 4. Incidentally, the controlling part 91 is implemented by using a central processing unit (CPU) (not illustrated in the figure) provided to the reader/writer apparatus 2, a read-only-memory (ROM) (not illustrated in the figure) in which programs for control and the like are stored, and a random access memory (RAM) (not illustrated in the figure) that is a working memory for the CPU.

Next, when the first sensor S1 detects the sheet S, the controlling part 91 causes the barcode reader Br to read the sheet identification barcode BK printed on the sheet S, and thereby acquiring the sheet identification number (step 102). Subsequently, the controlling part 91 functioning as a monitoring unit monitors the transportation condition of the sheet S, and thus determines whether or not an error occurs in the transportation of the sheet S (step 103). When determining in step 103 that a transportation error occurs, the controlling part 91 stops rotating the driving motors and thus stops the transportation of the sheet S (step 111). The information on the stop of the transportation of the sheet S is outputted to the controller 4. In response to this, the controller 4 causes an error display to be shown on the display panel 4a (step 112) and terminates the processing. Incidentally, a display panel may be provided to the reader/writer apparatus 2, and the error display may also be shown on this display panel. The transportation error in step 103 will be described in detail later.

On the other hand, when not determining in step 103 that a transportation error occurs, the controlling part 91 stops rotating the driving motors, and stops the transportation of the sheet S (step 104). This stopping processing is performed after a predetermined time period from when the second sensor S2 detects the sheet S. As a result, the sheet S is stopped at a predetermined position between the first suppressing unit 71 and the second suppressing unit 72. Specifically, the sheet S is stopped so that the tags T1 to T8 are arranged in the positions facing the respective closed spaces H1 to H8.

Thereafter, the controlling part 91 reads the identification information from the tags T1 to T8 embedded in the labels L1 to L8 through the reader/writer parts 61 to 68, respectively (step 105). Here, in the first exemplary embodiment, the identification information is read from the respective tags T at substantially same timings. To be more precise, in the first exemplary embodiment, the controlling part 91 sequentially operates the reader/writer parts 61 to 68 at slightly different timings. For this reason, the identification information is read from the respective tags Tat slightly different timings. After that, the controlling part 91 outputs each piece of the identification information read in step 105, to the data server 3 through the transmission-receiving part 92 functioning as a transmitting unit (step 106). As described above, for example, when the reader/writer part 61 reads the identification information from the tag T, the read identification information is stored in the data server 3 in association with the detailed information related to the position information (X1, Y1). Moreover, for example, when the reader/writer part 67 reads the identification information from the tag T, the read identification information is stored in the data server 3 in association with the detailed information related to the position information (X2, Y3).

Additionally, when not determining that a transportation error occurs in step 103, the controlling part 91 and the like perform the following operation in parallel with the above operations in steps 104 to 106.

The controlling part 91 firstly transmits the sheet identification number acquired in step 102, to the data server 3 through the transmission-receiving part 92 (step 109). Then, each of the reader/writer parts 61 to 68 receives the detailed information transmitted from the data server 3, through the transmission-receiving part 92 (step 110). As described above, for example, the detailed information such as the library name 34, the barcode information 35 and the book title 36 related to the position information (X1, Y1) is outputted to the reader/writer part 61, and, for example, the detailed information such as the library name 34, the barcode information 35 and the book title 36 related to the position information (X2, Y3) is outputted to the reader/writer part 67. Thus, the reader/writer parts 61 and 67 receive the detailed information related to the position information (X1, Y1) and (X2, Y3), respectively.

Next, the reader/writer parts 61 to 68 write the detailed information received in step 110, to the respective tags T1 to T8 embedded in the labels L1 to L8 (step 107). In the first exemplary embodiment, the reader/writer parts 61 to 68 perform the writing operations to the respective tags T1 to T8 at substantially same timings. Thereafter, the controlling part 91 restarts the transportation of the sheet S by restarting rotating the driving motor, thereby the sheet S is discharged outside the main body 40 (stores the sheet S in the storage unit 57) (step 108), and then terminates the processing.

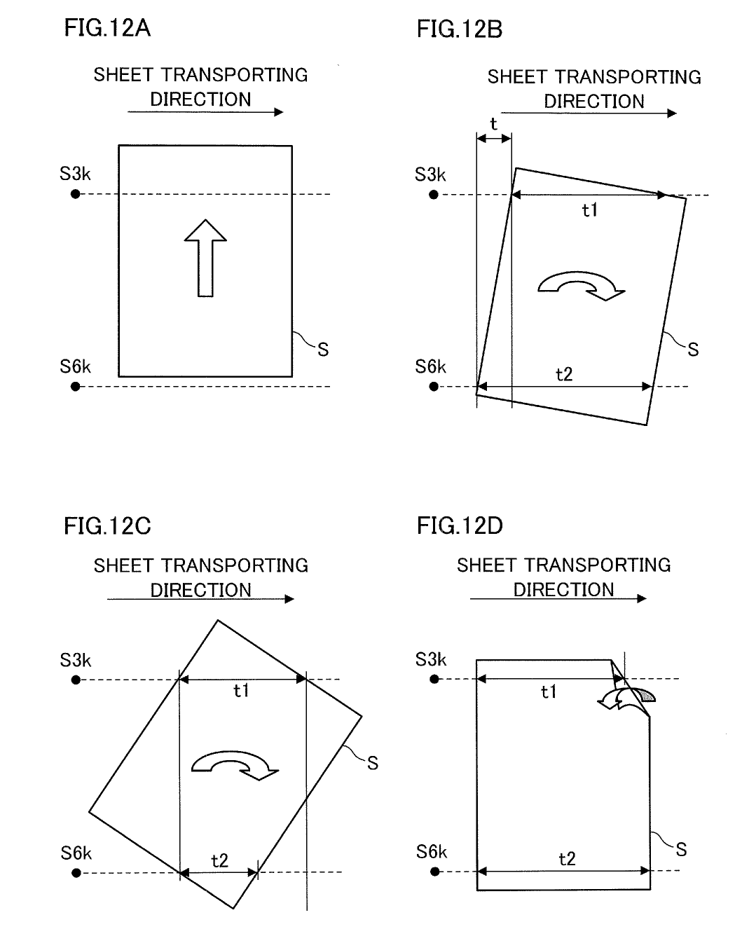

FIGS. 12A to 12D are diagrams for explaining errors in the transportation of the sheet S.

When a transportation error of the sheet S occurs, the wrong information may be written to the tags T and the identification information may be read from the wrong tags T. For this reason, in the first exemplary embodiment, it is determined whether or not a transportation error occurs, as described in the foregoing step 103.

The determination as to a transportation error in the first exemplary embodiment is made based on the detection results of the third sensor S3 and the sixth sensor S6, because the first exemplary embodiment has been described by using, as one example, the case where the sheet S of A4 size is transported. Alternatively, in the case where the sheet S of A6 size is transported, the determination as to a transportation error is made based on the detection results of the fourth sensor S4 and the fifth sensor S5 (see FIGS. 4 and 6).

FIG. 12A shows that the sheet S is transported with its position shifted to one side in a direction perpendicular to the sheet transporting direction. In this transportation state, the third sensor S3 outputs a detection signal, while the sixth sensor S6 outputs no detection signal. The controlling part 91 determines that a transportation error occurs if only one of the sensors outputs the detection signal.

FIG. 12B shows that the sheet S is transported while being skewed with respect to the sheet transporting direction. In this transportation state, there is a difference between a signal-output time t1 of the third sensor S3, and a signal-output time t2 of the sixth sensor S6. The controlling part 91 determines that a transportation error occurs, if a time difference t between the starting-time points of the signal-output times t1 and t2 is greater than a certain threshold, for example.

FIG. 12C shows that the sheet S is skewed further than in the transportation state in FIG. 12B. In this transportation state, as similar to the above state, the controlling part 91 also determines that a transportation error occurs, if the time difference t between the starting-time points of the signal-output times t1 and t2 is greater than the certain threshold. Instead, the controlling part 91 may determine that a transportation error occurs if the shorter one of the signal-output times t1 and t2 (the signal-output time t2 in the exemplary embodiment) is smaller than a certain threshold, for example.

FIG. 12D shows that a (corner) part of the sheet S is bent. In this transportation state, the signal-output time t2 of the sixth sensor S6 takes a certain value determined in advance. The signal-output time t1 of the third sensor S3, however, takes a value smaller than the certain value. In this way, the controlling part 91 may also determine that a transportation error occurs if only one of the signal-output times takes a value smaller than the certain value.

The controlling part 91 may determine whether or not the detailed information is written correctly, by reading the detailed information from each of the tags T after the execution of foregoing step 107, and then by comparing the read detailed information with detailed information written in step 107.

Moreover, the sheet S is temporarily stopped in the first exemplary embodiment. Alternatively, the information may be read and be written while the sheet S is being transported at a low speed. In the first exemplary embodiment, the detailed information is written after the identification information is read out, but the identification information may be read out after the detailed information is written.

Additionally, each of the reader/writer parts 61 to 68 is configured to perform both the reading operation and the writing operation in the first exemplary embodiment. Instead, the reader/writer parts may be configured of multiple reader parts and a writer part by dividing the above function of the reader/writer parts into two. In this configuration, for example, the multiple reader parts firstly read the respective pieces of identification information, and then the writer part writes the detailed information. When writing the respective pieces of detailed information to the tags, the writer part already knows the identification information of each of the tags by means of the reader parts. Hence, the single writer part may write the detailed information to all the tags.

Otherwise, the reader/writer apparatus 2 may only have a function of reading the identification information, and another apparatus may write the detailed information to the tags.

Further, although the example in which the sheet S is transported horizontally has been described in the first exemplary embodiment, the sheet S may be transported substantially vertically or obliquely with the first belt unit 53 and the second belt unit 54 rotated 90 degrees or arranged obliquely. With this configuration, the reader/writer apparatus 2 may be downsized in width or length. Furthermore, the example in which the sheet S is transported has been described in the first exemplary embodiment. Instead, in another employable configuration, the sheet S is stopped while the reader/writer parts 61 to 68, the first suppressing unit 71, the second suppressing unit 72 and the like are moved. Additionally, the first exemplary embodiment employs the sheets S separate from each other, but may employ a configuration in which a roll of sheet is sequentially fed to the reader/writer apparatus 2.

In the first exemplary embodiment, the detailed information is written to each of the tags T after the completion of the processing of the above step 108. In addition, both the detailed information and the identification information on the tags T, to which the detailed information is written, are stored in association with each other in the data server 3. Accordingly, if the labels L are attached to books to be lent out, and if the information inside the data server 3 is transferred to an administration terminal in a library or the like, a management system based on RFID is constructed. This management system allows various kinds of processing such as lending processing and returning processing to be performed smoothly as compared with the case of the conventional processing with barcodes or the like. Moreover, the various kinds of processing are also speeded up drastically.

Incidentally, although the example in which the information inside the data server 3 is transferred to the administration terminal has been described above, there is another employable configuration in which a terminal in a library accesses the data server 3, or in which the data server 3 itself is installed in the library.

The processing system in the first exemplary embodiment collectively and almost simultaneously writes the information to the multiple tags T embedded in the sheet S. For this reason, the speed for writing the information onto the sheet S (the sheet S production speed) is dramatically increased as compared with the conventional case. If the processing system intends to write the detailed information to each of the tags T without knowing the identification information of each of the tags T, information different from that already printed on each of the labels L may be written in some cases. In contrast, since the processing system in the first exemplary embodiment is configured of the multiple reader/writer parts corresponding to the respective tags T, the processing system writes, to the tags T, the detailed information corresponding to the printed information even without knowing the identification information of the tags T.

Moreover, if the multiple reader/writer parts are provided, the information may not appropriately be written to the tags T due to the interference of radio waves or the like. In the first exemplary embodiment, however, the information is surely written to the tags T because the first suppressing unit 71 and the second suppressing unit 72 are provided. Note that, although the reader/writer parts 61 to 68 may be provided at positions spaced away from each other in order to prevent the interference of radio waves, this configuration requires an increase in the size of the apparatus. The provision of the first suppressing unit 71 and the like as in the first exemplary embodiment leads to an achievement of downsizing the apparatus.

The first exemplary embodiment employs the configuration in which the detailed information is acquired from the data server 3. However, code images of two-dimensional barcodes or the like including the detailed information may be printed on the surface of the sheet S, and the detailed information may be acquired by reading these code images. In other words, the detailed information may be not acquired from the data server 3 but acquired from the sheet S. Alternatively, the detailed information may be included in the barcodes of the respective labels L, and the detailed information may be acquired by reading the barcodes.

In the foregoing description, the image forming apparatus 1 forms the images on the surface of the sheet S, and then the reader/writer apparatus 2 reads the identification information and writes the detailed information.

Instead, the reader/writer apparatus 2 firstly may read the identification information and write the detailed information, and then the image forming apparatus 1 may form the images on the surface of the sheet S.

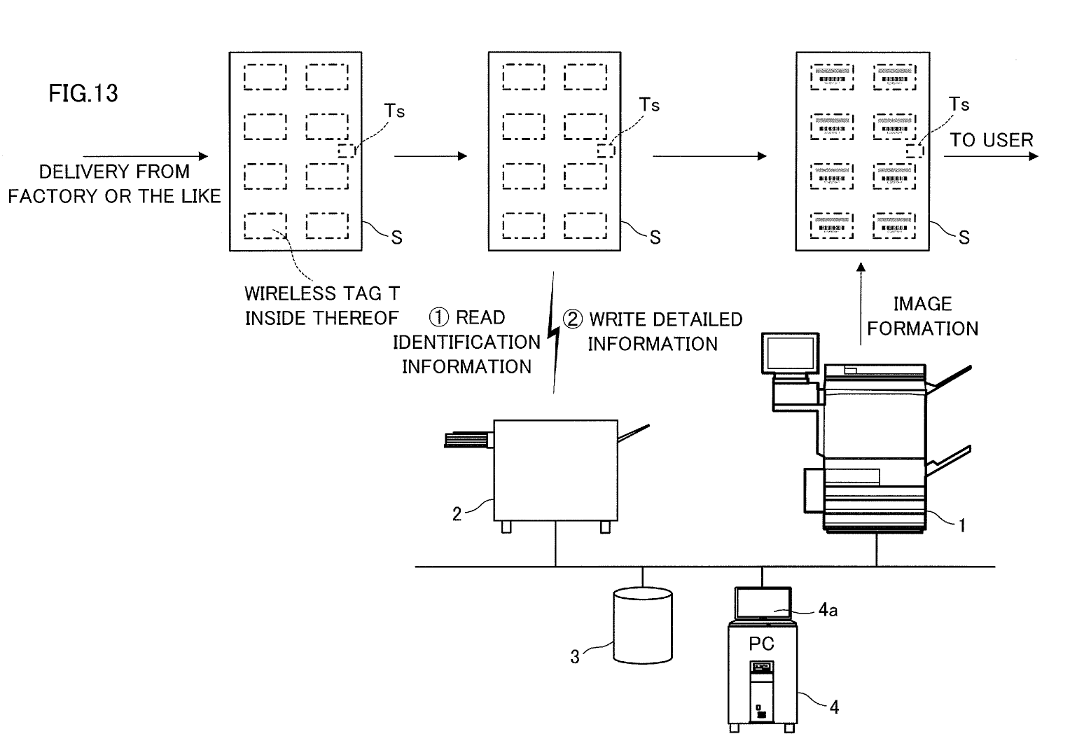

FIG. 13 shows a system for a case where the image forming apparatus 1 forms images after the reader/writer apparatus 2 performs the reading and writing operations.

In this system, an identification-number tag Ts having a sheet identification number stored therein is embedded in a sheet S, for example. In addition, the image forming apparatus 1 is provided with a reader part (not shown) that reads the sheet identification number from the identification-number tag Ts. Moreover, the reader/writer apparatus 2 is provided with a writer part (not shown) that writes the sheet identification number to the identification-number tag Ts.

In the case of this system, the reader/writer apparatus 2 firstly reads the identification information of each of the tags T, and then writes the detailed information to each of the tags T. The identification information thus read is outputted to the data server 3 as is the case of the aforementioned step 106. Moreover, in this system, the writer part provided to the reader/writer apparatus 2 writes the sheet identification number to the identification-number tag Ts.

Subsequently, the image forming apparatus 1 forms images on the surface of the sheet S. The image forming apparatus 1 reads the sheet identification number of the sheet S, from the identification-number tag Ts in the sheet S. Next, the image forming apparatus 1 acquires the position information 33 and the detailed information from the data server 3, according to the sheet identification number. After that, the image forming apparatus 1 generates the images based on these kinds of information and forms the images on the surface of the sheet S.

This system having the foregoing configuration also produces a sheet S having images formed (information printed) thereon, having the detailed information written to the tags T, and having the identification information read from the tags T. Incidentally, although the reader/writer apparatus 2 firstly reads the identification information and then writes the detailed information here, the reader/writer apparatus 2 may also write the detailed information firstly and then read the identification information.

### Second Exemplary Embodiment

Hereinafter, a second exemplary embodiment will be described. In the second exemplary embodiment, a first suppressing unit 71 in a reader/writer apparatus 2 is formed in a shape different from that in the first exemplary embodiment.

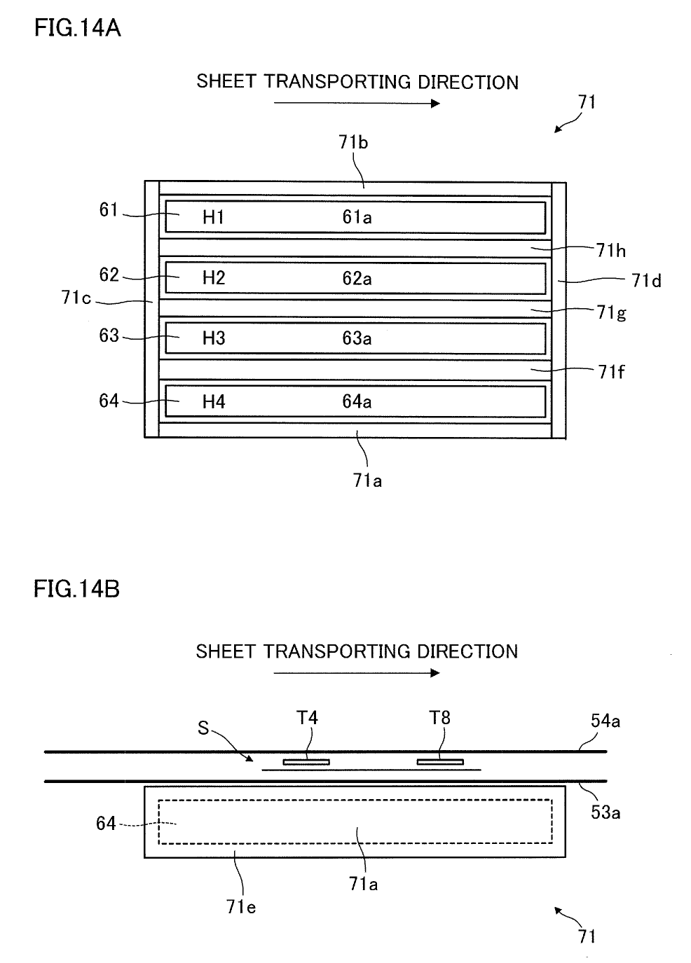

FIG. 14A shows a top view of the first suppressing unit 71 in the second exemplary embodiment. FIG. 14B shows a front view of the first suppressing unit 71 in the second exemplary embodiment. A belt member 53a, a belt member 54a and a sheet S are shown in the front view, while being omitted in the top view.

In the second exemplary embodiment, the first suppressing unit 71 is formed to have a rectangular parallelepiped shape and a rectangular shape as similar to the first exemplary embodiment, and includes a first side wall 71a, a second side wall 71b, a third side wall 71c, a fourth side wall 71d and a bottom portion 71e. Additionally, as similar to the first exemplary embodiment, the first suppressing unit 71 includes a second partition member 71f, a third partition member 71g and a fourth partition member 71h, the three of which partition the internal space of the first suppressing unit 71 into 4 sections in a direction perpendicular to the sheet transporting direction.

On the other hand, unlike the first exemplary embodiment, the first suppressing unit 71 in the second exemplary embodiment is formed to have a longer length in a sheet transporting direction than a length in a direction perpendicular to the sheet transporting direction. Moreover, in response to this shape difference, the second partition member 71f, the third partition member 71g and the fourth partition member 71h are each formed to have a length longer than that in the first exemplary embodiment. In addition, even though the first partition member 71k (see FIG. 6) for partitioning the internal space into two sections in the sheet transporting direction is provided in the first exemplary embodiment, any partition member for partitioning the internal space in the sheet transporting direction is not provided in the second exemplary embodiment. As a result, as shown in FIG. 14A, the first suppressing unit 71 in the second exemplary embodiment is configured of four closed spaces H1 to H4 each formed to have a rectangular cross section and to have a shorter length in the direction perpendicular to the sheet transporting direction than that in the sheet transporting direction. Further, antennas 61a to 64a (reader/writer parts 61 to 64) are provided to the respective four closed spaces H1 to H4 in the second exemplary embodiment.

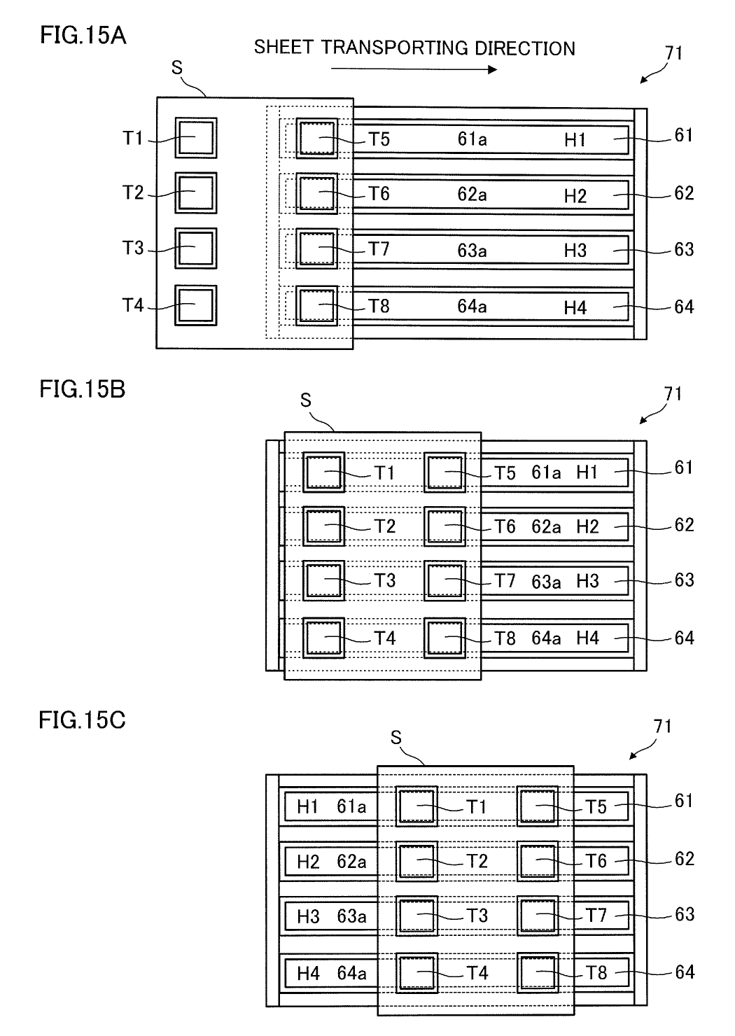

FIGS. 15A to 15C are diagrams for explaining operations of the reader/writer parts 61 to 64.

In the second exemplary embodiment, when the transportation of the sheet S starts, the four tags T5 to T8 arranged on the downstream side in the sheet transporting direction go into the positions facing the corresponding closed spaces H1 to H4 as shown in FIG. 15A. In other words, the four tags T5 to T8 arranged on the downstream side in the sheet transporting direction reach the radiation areas of radio waves (communication areas). Then, in the second exemplary embodiment, the identification information is read from each of the four tags T5 to T8 and the detailed information is written to each of the four tags T5 to T8 in this state.

Subsequently, when the sheet S is further transported, the four tags T1 to T4 arranged on the upstream side in the sheet transporting direction go into the positions facing the corresponding closed spaces H1 to H4 as shown in FIG. 15B. Then, the identification information is read from each of the four tags T1 to T4 and the detailed information is written to each of the four tags T1 to T4. When the reader/writer parts 61 to 64 read the pieces of identification information in the state shown in FIG. 15B, the reader/writer parts 61 to 64 also read the pieces of identification information from the tags T5 to T8 arranged on the downstream side in the sheet transporting direction. However, since the identification information is already read from the tags T5 to T8 in the state shown in FIG. 15A, the reader/writer parts 61 to 64 identify and acquire only the identification information from the tags T1 to T4 arranged on the upstream side in the sheet transporting direction.

The reader/writer parts 61 to 64 may also collectively write the detailed information to all the tags T1 to T8 after acquiring the identification information on all the tags T1 to T8. For example, the reader/writer parts 61 to 64 firstly read and obtain the pieces of identification information on the tags T5 to T8 arranged on the downstream side in the sheet transporting direction in the state shown in FIG. 15A. Thereafter, in the state shown in FIG. 15B, the reader/writer parts 61 to 64 read and acquire the pieces of identification information on the tags T1 to T4 arranged on the upstream side in the sheet transporting direction. Consequently, all the pieces of identification information on the tags T1 to T8 are acquired. After that, the reader/writer parts 61 to 64 collectively write the detailed information to all the tags T1 to T8 by use of the acquired identification information, for example, in the state shown in FIG. 15C.

The second exemplary embodiment has the four closed spaces H1 to H4 (the four opening portions of the closed spaces H1 to H4) each formed to extend in the sheet S transporting direction without having the first partition member 71k formed therein as in the first exemplary embodiment. Accordingly, a control for stopping the tags T1 to T8 in the positions facing the eight closed spaces H1 to H8, respectively, is made in the first exemplary embodiment. In contrast, such a control is unnecessary in the second exemplary embodiment, so that the control may be made simpler.

In addition, if the transportation of a sheet S is stopped and restarted, the posture of the sheet S may be disordered, which may produce a problem of reducing the storage capacity of the sheets S in the storage unit 57 (see FIG. 4), for example. In the second exemplary embodiment, the sheets S are transported without being stopped, and accordingly the storage unit 57 is maintained to have a large storage capacity for the sheets S. Moreover, since the sheets S are transported without being stopped, more sheets S are processible in a certain period of time than otherwise.

Incidentally, the transportation speed of the sheet S may either be constant, or be lowered when the sheet S passes by the antennas 61a to 64a. In the latter case, the reading and writing accuracy is improved. Here, a second suppressing unit 72 may be arranged in an opposite position to the first suppressing unit 71 with the belt members 53a and 54a interposed therebetween as is the case with the first exemplary embodiment. The second suppressing unit 72 may be formed to have the same shape as that of the first suppressing unit 71 in the second exemplary embodiment.

### Third Exemplary Embodiment

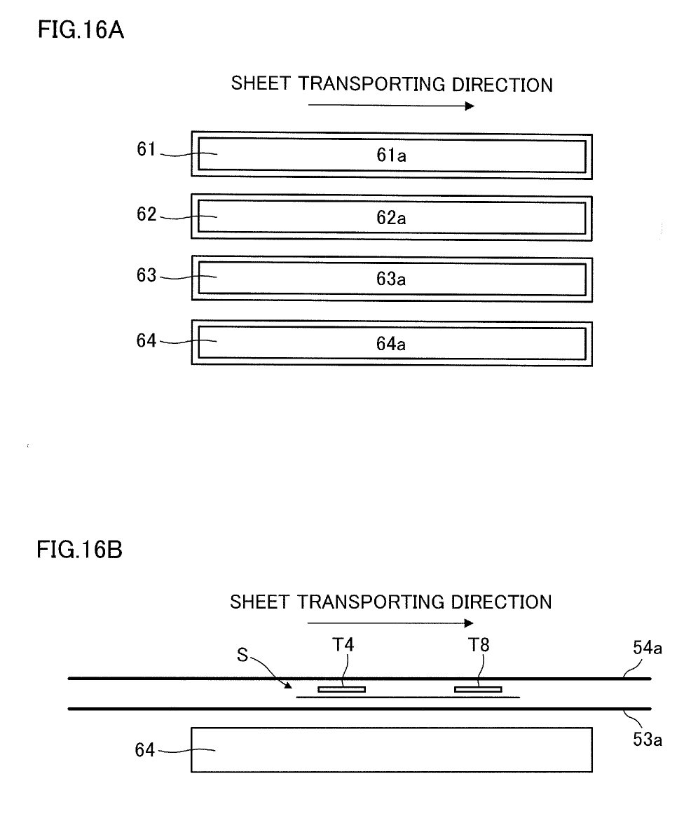

Hereinafter, a third exemplary embodiment will be described. This third exemplary embodiment has a configuration provided with reader/writer parts 61 to 64 as similar to the second exemplary embodiment but not provided with a first suppressing unit 71. FIG. 16A shows a top view of the reader/writer parts 61 to 64 in the third exemplary embodiment. FIG. 16B shows a front view of the reader/writer parts 61 to 64 in the third exemplary embodiment. A belt member 53a, a belt member 54a and a sheet S are shown in the front view, while being omitted in the top view.

In the third exemplary embodiment, the antennas 61a to 64a (reader/writer parts 61 to 64) extending along the sheet S transporting direction are arranged in parallel in a direction perpendicular to the sheet S transporting direction, as in the second exemplary embodiment. Incidentally, the first suppressing unit 71 is not provided in the third exemplary embodiment. Accordingly, when each of the reader/writer parts 61 to 64 transmits radio waves, the transmitted radio waves may interfere with each other. This interference is likely to impede the reader/writer parts 61 to 64 from reading the identification information and from writing the detailed information, correctly.

In the third exemplary embodiment, the reader/writer parts 61 to 64 are selectively operated in a time sharing to prevent the interference of radio waves. In other words, the reader/writer parts 61 to 64 are caused to transmit the radio waves at different timings, so that the interference of radio waves is avoided.

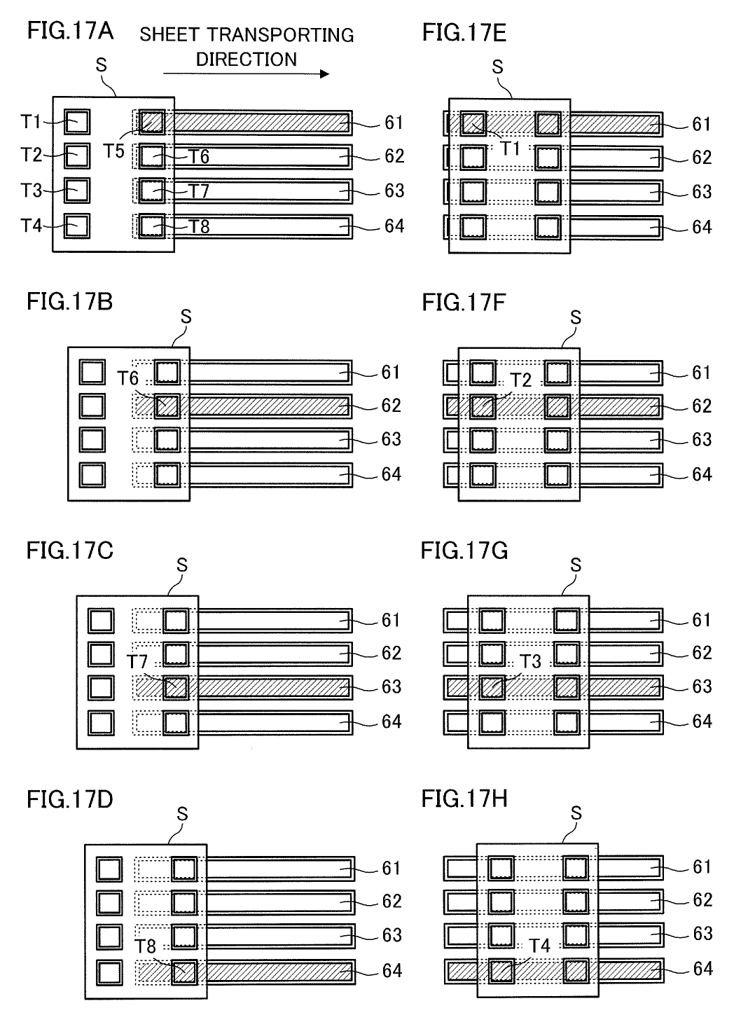

FIGS. 17A to 17H are diagrams for explaining operations of the reader/writer parts 61 to 64 when the sheet S is transported.

In the third exemplary embodiment, when the transportation of the sheet S starts, the four tags T5 to T8 arranged on the downstream side in the sheet transporting direction go into the positions facing the corresponding antennas 61a to 64a (the corresponding reader/writer parts 61 to 64) as shown in FIG. 17A. In other words, the four tags T5 to T8 arranged on the downstream side in the sheet transporting direction reach the radiation (transmission) areas of radio waves. Incidentally, in the third exemplary embodiment, operations to read the identification information and write the detailed information are performed while the sheet S is transported.

Then, in the third exemplary embodiment, the reader/writer parts 61 to 64 are supposed to transmit the radio waves to the respective tags T5 to T8. If the radio waves are transmitted at the same timing, however, the radio waves interfere with each other as described above. To avoid this, processing for selectively causing the reader/writer parts 61 to 64 to operate at different timings is executed in the third exemplary embodiment.

First, as shown in FIG. 17A, the reader/writer part 61 arranged in one end (the upper end in FIG. 17A) in the direction perpendicular to the sheet transporting direction is operated to read the identification information from the tag T5, and to write the detailed information to the tag T5.

Next, as shown in FIG. 17B, the reader/writer part 62 in the second position from the top is operated to read the identification information from the tag T6 and to write the detailed information to the tag T6. Subsequently, the reader/writer part 63 in the third position from the top is operated to read the identification information from the tag T7 and to write the detailed information to the tag T7 (see FIG. 17C). After that, the reader/writer part 64 in the lowest position is operated to read the identification information from the tag T8 and to write the detailed information to the tag T8 (see FIG. 17D).

Subsequently, the sheet S is further transported, and accordingly the four tags T1 to T4 arranged on the upstream side in the sheet transporting direction go into the positions facing the respective antennas 61a to 64a (reader/writer parts 61 to 64). At this time, the reader/writer part 61 is again operated to read the identification information from the tag T1, and to write the detailed information to the tag T1 (see FIG. 17E). Then, the reader/writer parts 62 to 64 are operated in turn from the top to the bottom, and thereby reading the identification information from the tags T2 to T4 and writing the detailed information to the tags T2 to T4, respectively (see FIGS. 17F to 17H).

In the third exemplary embodiment, as similar to the second exemplary embodiment, the reader/writer parts 61 to 64 surely read the identification information from the tags T and write the detailed information to the tags T while the sheet S is continuously transported. Accordingly, more sheets S are processible within a certain period of time than otherwise.

Moreover, the transportation of the sheets S is not required to stop. This makes a simple transportation control applicable, and leads to an improvement of the storage capacity of the storage unit 57, as in the case of the second exemplary embodiment. Moreover, the third exemplary embodiment is configured without including a first suppressing unit 71 or a second suppressing unit 72, and this configuration contributes to an achievement of the provision of a wireless tag processing apparatus lighter in weight and smaller in size. In addition, this configuration allows an opening-and-closing plate 41 to be opened and closed only with a relatively weak force, thereby increasing customer convenience.

It should be noted that, if the first suppressing unit 71 and the like are not provided as in the third exemplary embodiment, the radio-wave output level from each of the reader/writer parts 61 to 64 needs to be low enough to prevent the identification information from being read from the tags T adjacent to the target tag. In addition, although the reader/writer parts 61 to 64 are sequentially operated in the third exemplary embodiment, the reader/writer part 61 and the reader/writer part 64 arranged farthest from the reader/writer part 61 may be operated at the same timing, for example. In this case, the radio-wave output levels of the reader/writer parts 61 and 64 need to be set such that the radio waves transmitted from the reader/writer parts 61 and 64 do not interfere with each other.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A wireless tag processing apparatus comprising:
a transportation unit that transports a medium holding a plurality of wireless tags; and
a plurality of at least selected ones from writing units and reading units arranged so as to perform at least any one of an operation to write information with respect to each of the plurality of wireless tags in the medium transported by the transportation unit, and an operation to read information from each of the plurality of wireless tags.

2. The wireless tag processing apparatus according to claim 1, further comprising a suppressing unit that suppresses interference of radio waves transmitted by each of the plurality of at least selected ones from the writing units and the reading units.

3. The wireless tag processing apparatus according to claim 2, wherein the suppressing unit suppresses the interference of radio waves at both sides of a transporting path of the medium.

4. The wireless tag processing apparatus according to claim 2, wherein
the suppressing unit includes a transmitter-side shielding member between the plurality of at least selected ones from the writing units and the reading units that are provided, the transmitter-side shielding member shielding radio waves transmitted by at least selected ones from the writing units and the reading units

5. The wireless tag processing apparatus according to claim 4, wherein
the transmitter-side shielding member includes a portion having an opening formed thereon, the portion having the opening allowing radio waves to be transmitted from at least selected ones from the writing units and the reading units to the wireless tags, and
at least selected ones from the writing unit and the reading units are arranged farther away from the transporting path of the medium than the portion having the opening.

6. The wireless tag processing apparatus according to claim 4, wherein
the transmitter-side shielding member includes a portion having an opening formed thereon, the portion having the opening allowing radio waves to be transmitted from at least selected ones from the writing units and the reading units to the wireless tags, and
the portion having the opening is formed in a shape extending in a transporting direction of the medium transported by the transportation unit.

7. The wireless tag processing apparatus according to claim 4, wherein the transportation unit curves the wireless tags in the medium and at least selected ones from the writing units and the reading units so as to be inclined and transports the medium.

8. The wireless tag processing apparatus according to claim 4, wherein
the suppressing unit further comprises an opposite-side shielding member that shields radio waves transmitted by at least selected ones from the writing units and the reading units, in an opposite position to the transmitter-side shielding member across a medium transporting path, and
the suppressing unit suppresses the interference of radio waves by further using the opposite-side shielding member.

9. The wireless tag processing apparatus according to claim 8, wherein the opposite-side shielding member is formed to have a shorter length than the transmitter-side shielding member in a direction perpendicular to the medium transporting path.

10. The wireless tag processing apparatus according to claim 8, wherein one of the transmitter-side shielding member and the opposite-side shielding member is provided to be movable for moving away from the other shielding member.

11. The wireless tag processing apparatus according to claim 1, wherein
each of the plurality of at least selected ones from the writing units and the reading units includes one of antennas, and
the plurality of antennas are arranged at different angles relative to a direction.

12. The wireless tag processing apparatus according to claim 1, wherein
the transportation unit transports the medium in which the plurality of wireless tags are arranged with a predetermined positional relationship; and
the plurality of at least selected ones from the writing units and the reading units are provided in positions corresponding to the positional relationship of the plurality of wireless tags, and individually perform at least any one of the operation to write the information to each of the plurality of wireless tags arranged in the medium transported by the transportation unit, and the operation to read the information from each of the plurality of wireless tags.

13. The wireless tag processing apparatus according to claim 12, wherein each of the plurality of reading units reads unique identification information stored in the wireless tag, from each of the plurality of wireless tags, and each of the plurality of writing units writes information on a tag-attached object to each of the wireless tags.

14. The wireless tag processing apparatus according to claim 1, wherein
the plurality of reading units read the information by using radio waves, and
each of the plurality of reading units reads the information from each of the plurality of wireless tags by transmitting radio waves at different timing.

15. The wireless tag processing apparatus according to claim 1, wherein the transportation unit transports the medium while nipping the medium between belt members arranged facing each other.

16. The wireless tag processing apparatus according to claim 1, wherein the transportation unit transports the medium at a lower speed when the plurality of at least selected ones from the writing units and the reading units perform at least any one of a writing operation and a reading operation, than a speed before or after performing at least any one of the writing operation and the reading operation.

17. A processing system comprising:
a server that stores tag-attached object information on a tag-attached object to which a wireless tag is attached, and unique identification information stored in the wireless tag, in association with each other;
an image forming apparatus that forms images on a medium in which a plurality of the wireless tags are arranged with a predetermined positional relationship, based on the tag-attached object information stored in the server;
a wireless tag processing apparatus having:
a transportation unit that transports the medium;
a plurality of at least selected ones from writing units and reading units that are arranged in positions corresponding to the predetermined positional relationship of the plurality of wireless tags in the medium, and that individually perform at least any one of an operation to write the tag-attached object information acquired from the server, to each of the plurality of wireless tags arranged in the medium transported by the transportation unit, and an operation to read the unique identification information from each of the plurality of wireless tags; and
a transmitting unit that transmits the unique identification information read by each of at least selected ones from the writing units and the reading units, to the server.

18. The processing system according to claim 17, wherein
the server stores medium identification information for discriminating the medium from other media, in association with the tag-attached object information,
the image forming apparatus also forms, on the medium, an image representing the medium identification information, when forming the images based on the tag-attached object information on the medium, and
the wireless tag processing apparatus acquires the medium identification information from the image representing the medium identification information that is formed on the medium, and acquires the tag-attached object information associated with the medium identification information, from the server.

19. A wireless tag processing method comprising:
transporting a medium in which a plurality of wireless tags are arranged with a predetermined positional relationship; and
reading unique identification information stored in the wireless tag, from each of the plurality of wireless tags arranged in the transported medium, and
writing tag-attached object information on a tag-attached object to which the wireless tag is attached, to each of the wireless tags based on the read identification information of the wireless tag.
